(19) United States
(12) Patent Application Publication
(10) Pub. No.: US 2024/0221014 A1
(43) Pub. Date: Jul. 4, 2024

(54) INFORMATION PROCESSING DEVICE, INFORMATION PROCESSING METHOD, AND INFORMATION PROCESSING PROGRAM

(71) Applicant: DENTSU INC., Tokyo (JP)

(72) Inventors: Mihoko HOTTA, Tokyo (JP); Ryo SUETOMI, Tokyo (JP)

(73) Assignee: DENTSU INC., Tokyo (JP)

(21) Appl. No.: 18/563,123

(22) PCT Filed: Apr. 11, 2022
(86) PCT No.: PCT/JP2022/017468

§ 371 Date: Nov. 21, 2023

(30) Foreign Application Priority Data
May 27, 2021 (JP) 2021-089240

(51) Int. Cl. G06Q 30/0201

(52) U.S. Cl. CPC G06Q 30/0206

(57) ABSTRACT

An information processing device includes an input receiving unit that receives an input of a parameter for determining the specifications of an event to be held in virtual reality space; and an event execution unit that executes in the virtual reality space an event created based on the parameter. The input receiving unit further receives an input for setting an assessment item for the event and its target value. During execution of the event, the event execution unit performs measurement for the assessment item in real time, and compares the measurement value of the assessment item with the set target value, and then, when the measurement value of the assessment item is less than the target value, identifies a process to be performed corresponding to the assessment item by referring to a database storing a predetermined process for improving assessment for each assessment item, and executes the identified process.

### TECHNICAL FIELD

The present technology relates to an information processing device, an information processing method, and an information processing program.

### BACKGROUND ART

Conventionally, a service is known that allows an avatar to be operated in a virtual reality (VR) space so that the avatar may be able to visit another space (also referred to as “world”) or interact with other avatars (Non Patent Literature 1, for example). Sometimes, an event is held using such a service to allow avatars to be operated in a VR space so that the avatars may be able to enter a world that is a site of the event, and go around within the site or purchase some items (Non Patent Literature 2, for example).
Non Patent Literature 1: “VRChat,” [online], VRChat Inc., [searched May 7, 2021], the Internet <URL: https://hello.vrchat.com/>
Non Patent Literature 2: “VIRTUAL MARKET,” [online], HIKKY Co., Ltd., [searched Oct. 22, 2020], the Internet <URL: https://www.v-market.work>

Japanese Patent Laid-Open No. 2005-38373 proposes an event sales support system that includes means for receiving event data about an event to be held in a real space, means for creating an image of an event site in a virtual space, and means for calculating an estimate of the cost required to hold the event in the real space.

### SUMMARY OF INVENTION

By the way, a VR space has characteristics such that monitoring of data, such as the attributes of avatars operated by users, their activity logs, and interaction among the avatars, is all possible in real time. Conventionally, an event held in a VR space is assessed based on assessment items, such as the numbers of downloads of an application, the number of visitors, their time spent in the VR space, and the sales of products. However, such assessment is based only on the assessment calculated in real time, every day, or through the whole event period. Thus, there is a problem in that when a measurement value of an assessment item is found to be greater than or less than its preset target value during an event held in a VR space, it would be impossible to address such an issue in real time.

Thus, it is desired to provide a technique capable of maximizing the advantage of an event held in a VR space on a timely basis, utilizing the real-time property of the VR space.

An information processing device according to an aspect of the present disclosure includes an input receiving unit that receives an input of a parameter for determining a specification of an event to be held in a virtual reality space; and an event execution unit that executes in the virtual reality space an event created based on the parameter, in which the input receiving unit further receives an input for setting an assessment item for the event and a target value of the assessment item, and during execution of the event, the event execution unit performs measurement for the assessment item in real time, and compares a measurement value of the assessment item with the set target value, and then, when the measurement value of the assessment item is less than the target value, identifies a process to be performed corresponding to the assessment item by referring to a database that stores a predetermined process for improving assessment for each assessment item, and executes the identified process.

### BRIEF DESCRIPTION OF DRAWINGS

FIG. 1A is a view illustrating the schematic configuration of an information processing system according to an embodiment.

FIG. 1B is a block diagram illustrating the configuration of a server.

FIG. 1C is a block diagram illustrating the configuration of a host terminal.

FIG. 1D is a block diagram illustrating the configuration of a guest terminal.

FIG. 2 is a view illustrating an exemplary screen for inputting parameters for determining the specifications of an event to be held in a virtual reality space.

FIG. 3A is a flowchart illustrating an exemplary operation of the information processing system according to the embodiment.

FIG. 3B is a flowchart illustrating the exemplary operation of the information processing system according to the embodiment.

FIG. 4 is a table for illustrating patterns of a process to be executed by an event execution unit in accordance with a measurement result for an assessment item.

FIG. 5A is a table illustrating an exemplary database that stores a predetermined process for improving or maintaining assessment for each assessment item.

FIG. 5B is a table illustrating an exemplary database that stores a predetermined process for improving or maintaining assessment for each assessment item.

FIG. 5C is a table illustrating an exemplary database that stores a predetermined process for improving or maintaining assessment for each assessment item.

FIG. 5D is a table illustrating an exemplary database that stores a predetermined process for improving or maintaining assessment for each assessment item.

FIG. 5E is a table illustrating an exemplary database that stores a predetermined process for improving or maintaining assessment for each assessment item.

FIG. 6A is a view for illustrating a process of reducing the number of layers.

FIG. 6B is a view for illustrating a process of increasing the number of layers.

FIG. 7A is a view for illustrating a process of reducing the number of NPCs for livening up an event.

FIG. 7B is a view for illustrating a process of reducing the number of NPCs for livening up an event.

FIG. 8 is a view for illustrating a process performed when the measurement value of the sales of products is less than a target value.

### DESCRIPTION OF EMBODIMENT

An information processing device according to a first aspect of an embodiment includes an input receiving unit that receives an input of a parameter for determining a specification of an event to be held in a virtual reality space; and an event execution unit that executes in the virtual reality space an event created based on the parameter, in which the input receiving unit further receives an input for setting an assessment item for the event and a target value of the assessment item, and during execution of the event, the event execution unit performs measurement for the assessment item in real time, and compares a measurement value of the assessment item with the set target value, and then, when the measurement value of the assessment item is less than the target value, identifies a process to be performed corresponding to the assessment item by referring to a database that stores a predetermined process for improving assessment for each assessment item, and executes the identified process.

According to such an aspect, even when a measurement result for a predetermined assessment item has become less than its target value at a given time point during execution of an event held in a virtual reality (VR) space, a process for improving the assessment is executed immediately (in real time). This can recover from the low the assessment of the event at an early point, and thus can increase the advantage of the event. Thus, it is possible to maximize the advantage of the event held in the VR space on a timely basis, utilizing the real-time property of the VR space.

An information processing device according to a second aspect of the embodiment is the information processing device according to the first aspect, in which when the measurement value of the assessment item is greater than the target value, the event execution unit identifies a process to be performed corresponding to the assessment item by referring to a database that stores a predetermined process for maintaining assessment for each assessment item, and executes the identified process.

According to such an aspect, even when a measurement result for a predetermined assessment item has become greater than its target value at a given time point during execution of an event held in a virtual reality (VR) space, a process for maintaining the assessment is executed in real time. This can prevent the event from being assessed low during the execution of the event, and thus can even increase the advantage of the event. Thus, it is possible to even maximize the advantage of the event held in the VR space on a timely basis, utilizing the real-time property of the VR space.

An information processing device according to a third aspect of the embodiment is the information processing device according to the first or second aspect, in which the process includes one or more of a process applied to a world in which the event is being held, a process applied to a world different from the world in which the event is being held, and a process applied to a space outside of the virtual reality space.

An information processing device according to a fourth aspect of the embodiment is the information processing device according to the third aspect, in which the process applied to the world in which the event is being held includes at least one of changing the number of layers to which avatars belong in the world, changing an overall environment of the world, sending a message to an avatar in the world, and changing a content in the world.

An information processing device according to a fifth aspect of the embodiment is the information processing device according to the fourth aspect, in which the process applied to the world in which the event is being held includes at least one of changing an area of a site, changing the number of seats, changing the number of layers, changing the number of contents or non-player characters (NPCs) for livening up the event, changing the number or area of advertisements, distributing coupons, setting a bargain time, changing a social tipping item or a price of the social tipping item, changing a display of a signboard or an information guide or map, setting up or removing a warp door, changing the number of passages, changing a passage width, moving a product sales area or shop, changing an area or the number of squares or parks, and changing music, sound, season, time, weather, or an overall concept of the world.

An information processing device according to a sixth aspect of the embodiment is the information processing device according to the third aspect, in which the process applied to a world different from the world in which the event is being held includes at least one of sending a message to an avatar in the different world, and changing a content in the different world.

An information processing device according to a seventh aspect of the embodiment is the information processing device according to the third aspect, in which the process applied to a space outside of the virtual reality space includes at least one of sending an e-mail or making a telephone call, posting on an SNS, posting on a website, posting on a digital signage, and changing a content in the real world.

An information processing device according to an eighth aspect of the embodiment is the information processing device according to any one of the first to seventh aspects, in which the input receiving unit presents a plurality of predetermined candidates as an assessment item for the event, and receives selection of an assessment item to be set from among the plurality of candidates.

An information processing device according to a ninth aspect of the embodiment is the information processing device according to any one of the first to eighth aspects, in which the assessment item includes at least one of the number of visitors of the event, the number of downloads of an application for joining the event, going-around-behavior of a guest within the site, a movement status of the guest between areas inside and outside the site, feeling of the guest, sales of products, and a social tipping status.

An information processing device according to a tenth aspect of the embodiment is the information processing device according to the ninth aspect, in which the feeling is estimated based on biological information including at least one of a heart rate, a brain wave, a facial expression, an utterance, a pupil, a movement, and a physical action of the guest.

An information processing device according to an eleventh aspect of the embodiment is the information processing device according to any one of the first to tenth aspects, in which the specification of the event includes at least one of a type of the event, whether the event is held outdoors or indoors, season, time of a day, weather, the number of guests to be accommodated, a period, a duration, whether seats are provided, types of the guests, whether the event is free-of-charge or fee-based, whether an accommodation capacity is expandable, and whether products are sold.

An information processing device according to a twelfth aspect of the embodiment is the information processing device according to any one of the first to eleventh aspects, in which the input receiving unit creates a mock-up image of the event through real-time rendering based on the input parameter.

According to such an aspect, it is possible to input parameters for determining the specifications of an event to be held in the VR space while checking and considering a mock-up image of the event. Thus, it is possible to more easily create an event in the VR space.

An information processing device according to a thirteenth aspect of the embodiment is the information processing device according to any one of the first to twelfth aspects, in which the input receiving unit creates an approximate estimate of a cost of the event in real time based on the input parameter.

According to such an aspect, it is possible to input parameters for determining the specifications of an event to be held in the VR space while checking and considering an approximate estimate of the cost of the event. Thus, it is possible to more easily create an event in the VR space.

An information processing device according to a fourteenth aspect of the embodiment is the information processing device according to any one of the first to thirteenth aspects that further includes a report creation unit that, after execution of the event, creates a report including time-series assessment for each assessment item.

An information processing method according to a fifteenth aspect of the embodiment includes a step of receiving an input of a parameter for determining a specification of an event to be held in a virtual reality space, the step further including receiving an input for setting an assessment item for the event and a target value of the assessment item; and a step of executing in the virtual reality space an event created based on the parameter, the step further including, during execution of the event, performing measurement for the assessment item in real time, and comparing a measurement value of the assessment item with the set target value, and then, when the measurement value of the assessment item is less than the target value, identifying a process to be performed corresponding to the assessment item by referring to a database that stores a predetermined process for improving assessment for each assessment item, and executing the identified process.

An information processing program according to a sixteenth aspect of the embodiment causes a computer to execute a step of receiving an input of a parameter for determining a specification of an event to be held in a virtual reality space, the step further including receiving an input for setting an assessment item for the event and a target value of the assessment item; and a step of executing in the virtual reality space an event created based on the parameter, the step further including, during execution of the event, performing measurement for the assessment item in real time, and comparing a measurement value of the assessment item with the set target value, and then, when the measurement value of the assessment item is less than the target value, identifying a process to be performed corresponding to the assessment item by referring to a database that stores a predetermined process for improving assessment for each assessment item, and executing the identified process.

Hereinafter, specific examples of the embodiment will be described in detail with reference to the accompanying drawings. Throughout the following description and the drawings used therefor, portions that can have the same configuration are denoted by the same reference sign, and the overlapped description thereof will be omitted.

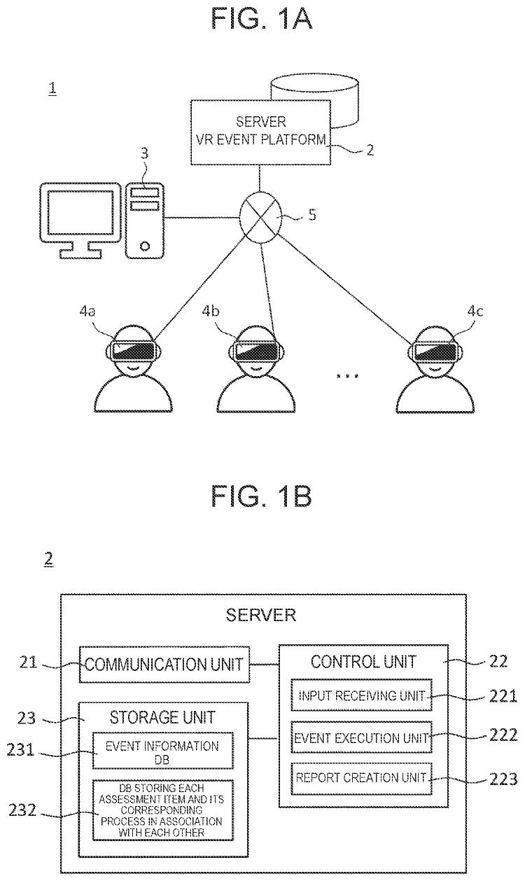

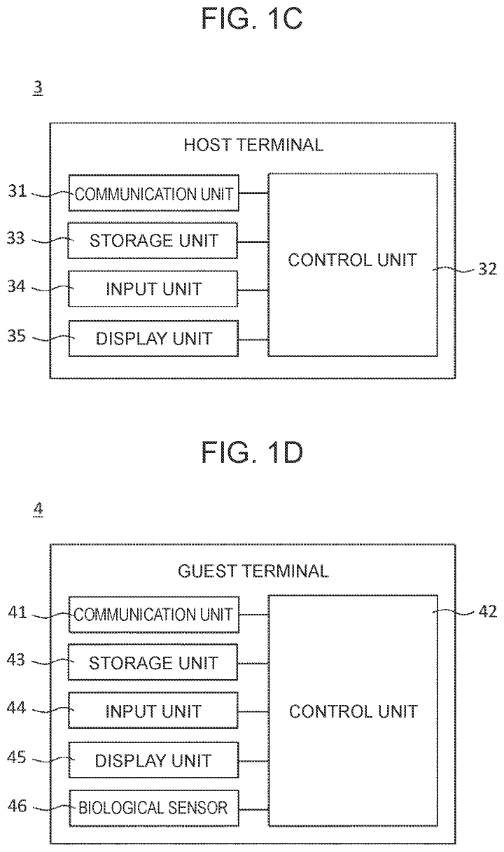

FIG. 1A is a view illustrating the schematic configuration of an information processing system 1 according to an embodiment. The information processing system 1 is a system for providing an event platform that can easily create, manage, and measure the advantage of an event held in a virtual reality (VR) space (hereinafter also referred to as a “VR event”).

As illustrated in FIG. 1A, the information processing system 1 includes a server 2 (i.e., an information processing device), a host terminal 3, and guest terminals 4a to 4c. The server 2, the host terminal 3, and the guest terminals 4a to 4c are communicably connected via a network 5, such as the Internet. The network 5 may be either a wired network or a wireless network, and the type and form of the network are not limited to particular ones. Note that at least some of the server 3, the host terminal 3, and the guest terminals 4a to 4c are implemented by computers.

Among them, the guest terminals 4a to 4c are used by guest users of the VR event (i.e., visitors of the event). Examples of the guest terminals 4a to 4c include electronic devices, such as head-mounted displays (HMDs), personal computers (PCs), smartphones, and tablet terminals. The guest terminals 4a to 4c have the same configuration. In the following description, the guest terminals shall be collectively denoted by reference sign 4.

FIG. 1D is a block diagram illustrating the configuration of the guest terminal 4. As illustrated in FIG. 1D, the guest terminal 4 includes a communication unit 41, a control unit 42, a storage unit 43, an input unit 44, a display unit 45, and a biological sensor 46. The units 41 to 46 are communicably connected.

The communication unit 41 is a communication interface between the guest terminal 4 and the network 5. The communication unit 41 transfers information between the guest terminal 4 and the server 2 via the network 5.

The control unit 42 is control means for performing various processes of the guest terminal 4. The control unit 42 may be implemented through execution of a predetermined program by a processor in the guest terminal 4, or may be implemented by hardware. The storage unit 43 is a nonvolatile data storage, such as a flash memory, for example. The storage unit 43 stores various types of data handled by the control unit 42.

The input unit 44 is an interface for the guest user of the VR event to input information to the guest terminal 4. Examples of the input unit 44 include a handheld controller of a head-mounted display; a touch panel or a microphone of a smartphone or a tablet terminal; and a touchpad, a keyboard, or a mouse of a personal computer. Herein, the handheld controller of the head-mounted display may include at least one operation button, and incorporate various sensors for detecting the orientation and motion (e.g., acceleration and rotation) of the controller. In addition, information may be input not only via the operation button or the controller but also based on the user's input of his/her movement or behavior through tracing of it with a sensor. By inputting an operation via the input unit 44, the user is able to allow his/her avatar to move or speak in the virtual reality space.

The display unit 45 is an interface for displaying various types of information for the guest user of the VR event on the guest terminal 3. Examples of the display unit 45 include video display means such as a liquid crystal display. When the guest terminal 4 is a head-mounted display, the display unit 45 is video display means of a type worn on the head of the user and is adapted to cover the visual fields of both eyes of the user. The user wearing the head-mounted display is able to watch a video displayed on the display unit 45. The display unit 45 displays a still image, a moving image, documents, websites, or any other objects (e.g., electronic files). The display form of the display unit 45 is not limited to a particular one. For example, an object may be displayed at any position in a deep virtual space (i.e., a virtual reality space), or an object may be displayed at any position on a virtual plane.

The biological sensor 46 is a sensor for obtaining biological information on the guest user of the VR event. The biological information obtained by the biological sensor 46 is not limited to a particular one as long as it can be used to estimate the feeling of the user. For example, the biological information may include at least one of the heart rate, a brain wave, a facial expression, an utterance, a pupil, a movement, and a physical action. That is, the biological sensor 46 may be a heart rate sensor, a brain wave sensor, a camera for capturing an image of a facial expression or a pupil, a microphone for obtaining voice, an accelerometer for measuring a movement or a physical action of the user, or a combination of two or more of them, for example.

Next, the host terminal 3 will be described. The host terminal 3 is used by a host user of the VR event (i.e., a creator or a manager of the event). Examples of the host terminal 3 include an electronic device, such as a head-mounted display (HMD), a personal computer (PC), a smartphone, and a tablet terminal.

FIG. 1C is a block diagram illustrating the configuration of the host terminal 3. As illustrated in FIG. 1C, the host terminal 3 includes a communication unit 31, a control unit 32, a storage unit 33, an input unit 34, and a display unit 35. The units 31 to 35 are communicably connected.

The communication unit 31 is a communication interface between the host terminal 3 and the network 5. The communication unit 31 transfers information between the host terminal 3 and the server 2 via the network 5.

The control unit 32 is control means for performing various processes of the host terminal 3. The control unit 32 may be implemented through execution of a predetermined program by a processor in the host terminal 3, or may be implemented by hardware. The storage unit 33 is a nonvolatile data storage, such as a hard disk or a flash memory, for example. The storage unit 33 stores various types of data handled by the control unit 32.

The input unit 34 is an interface for the host user of the VR event to input information to the host terminal 3. Examples of the input unit 34 include a handheld controller of a head-mounted display; a touch panel or a microphone of a smartphone or a tablet terminal; and a touchpad, a keyboard, or a mouse of a personal computer.

The display unit 35 is an interface for displaying various types of information for the host user of the VR event on the host terminal 3. Examples of the display unit 35 include video display means, such as a liquid crystal display. When the host terminal 3 is a head-mounted display, the display unit 35 is video display means of a type worn on the head of the user and is adapted to cover the visual fields of both eyes of the user. The user wearing the head-mounted display is able to watch a video displayed on the display unit 35.

Next, the server 2 will be described. The server 2 may include one computer, or a plurality of computers that are communicably connected via a network.

FIG. 1B is a block diagram illustrating the configuration of the server 2. As illustrated in FIG. 1B, the server 2 includes a communication unit 21, a control unit 22, and a storage unit 23. The units 21 to 23 are communicably connected.

Among them, the communication unit 21 is a communication interface between the server 2 and the network 5. The communication unit 21 transfers information between the server 2 and the host terminal 3 or the guest terminals 4a to 4c via the network 5.

The storage unit 23 is a nonvolatile data storage, such as a hard disk or a flash memory, for example. The storage unit 23 stores various types of data handled by the control unit 22. For example, the storage unit 23 includes an event information database 231 and a database 232 that stores each assessment item and its corresponding process in association with each other.

The event information database 231 stores, for each VR event, parameters for determining the specifications of the VR event; a mock-up image created based on the parameters; assessment items set for the VR event and their target values; time-series measurement values of each assessment item measured in real time during execution of the VR event; and a report created based on the time-series measurement values of the assessment item, for example.

The database 232 that stores each assessment item and its corresponding process in association with each other stores a predetermined process for improving or maintaining assessment for each assessment item.

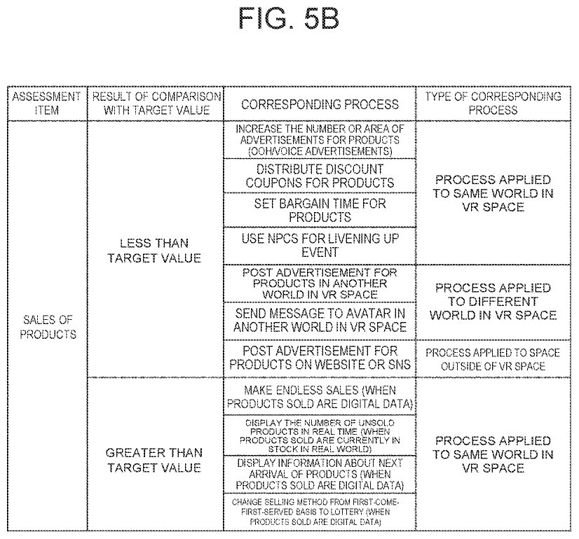

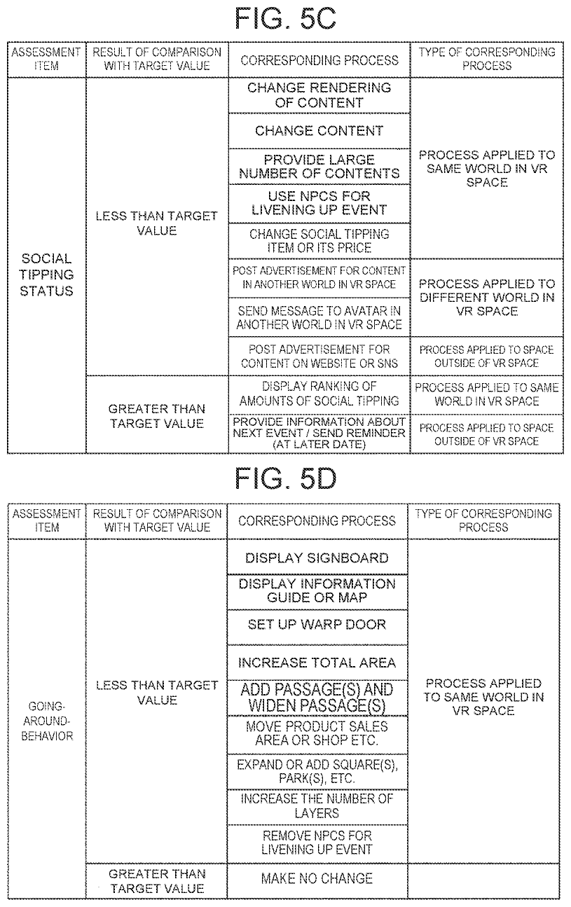

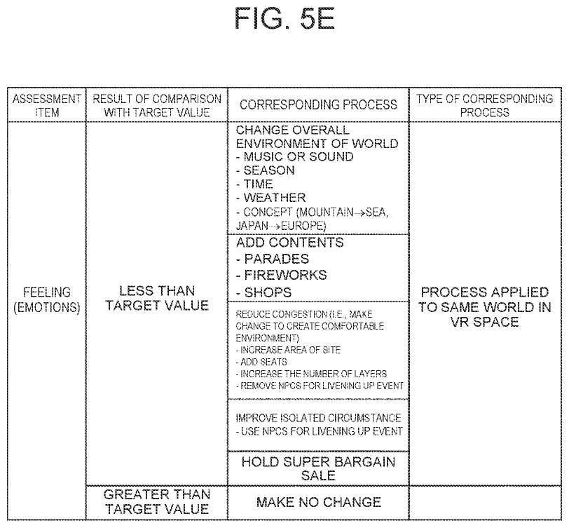

FIGS. 5A to 5E are tables each illustrating exemplary information stored in the database 232 that stores each assessment item and its corresponding process in association with each other.

In an example illustrated in FIG. 5A, the following processes are stored in association with an assessment item “the number of visitors” as a process for improving assessment (i.e., for increasing the number of visitors) when the measurement value of the assessment item is less than its target value: (a) reducing the area of the site, (b) removing seats, (c) reducing the number of layers, (d) using non-player characters (NPCs) for livening up the event, (e) posting an advertisement in another world in the VR space to inform that the event is being held, (f) sending a message to an avatar in another world in the VR space to inform that the event is being held, and (g) posting an advertisement on a predetermined website or social network service (SNS) to inform that the event is being held. In addition, the following processes are stored in association with the assessment item “the number of visitors” as a process for maintaining the assessment (i.e., for not having less visitors) when the measurement value of the assessment item is greater than its target value: (h) increasing the area of the site, (i) adding seats, (j) increasing the number of layers, and (k) removing the NPCs for livening up the event. Among them, the processes (a) to (d) and the processes (h) to (k) are applied to the world in which the event is being held in the VR space; the processes (e) and (f) are applied to a world different from the world in which the event is being held in the VR space; and the process (g) is applied to a space outside of the VR space.

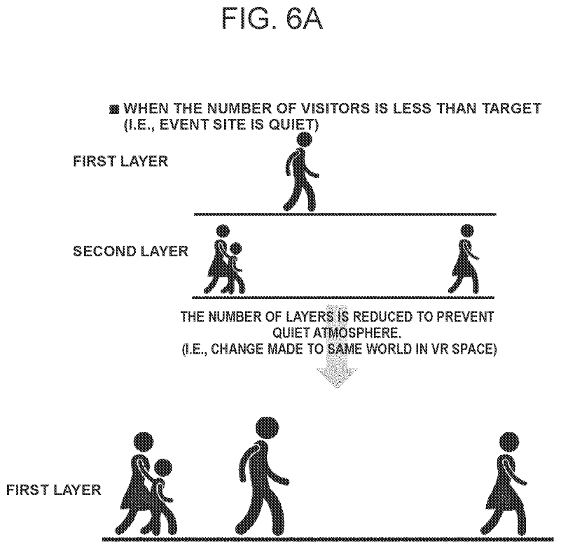

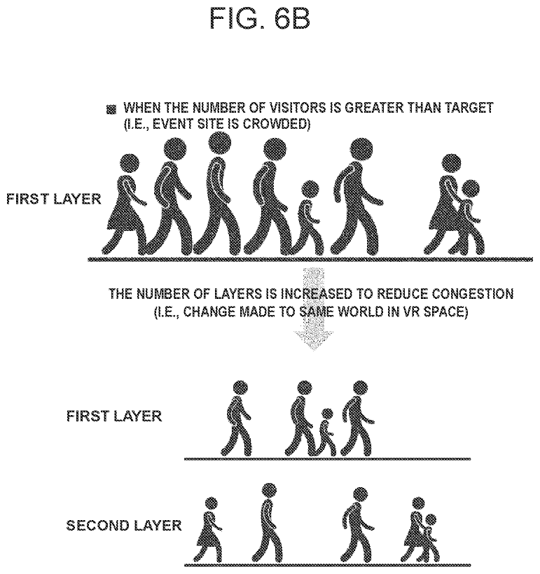

More specifically, each world in the VR space can include one or more layers in an overlapped state. When one world includes a plurality of layers in an overlapped state, each avatar who is present in the world is automatically allocated to one of the plurality of layers. In one world, each avatar is able to recognize, see, and talk to only other avatars belonging to the same layer in the same world, but is unable to recognize, see, or talk to other avatars belonging to other layers even in the same world. Such a layer function is utilized to perform, as illustrated in FIG. 6A, a process of reducing the number of layers (i.e., the process (c) above) when the measurement value of “the number of visitors” is less than its target value (i.e., when the event site is quiet). This can increase the number of avatars belonging to each layer (i.e., density), thus preventing a quiet atmosphere and creating an atmosphere that allows other avatars to feel like entering the site. This in turn leads to an increase in the number of visitors. Meanwhile, as illustrated in FIG. 6B, when the measurement value of “the number of visitors” is greater than its target value (i.e., when the event site is crowded), a process of increasing the number of layers (i.e., the process (j) above) is performed. This can reduce the number of avatars belonging to each layer (i.e., density), thus reducing congestion and creating an atmosphere that allows each avatar to stay comfortable within the site. This in turn can prevent a decrease in the number of visitors.

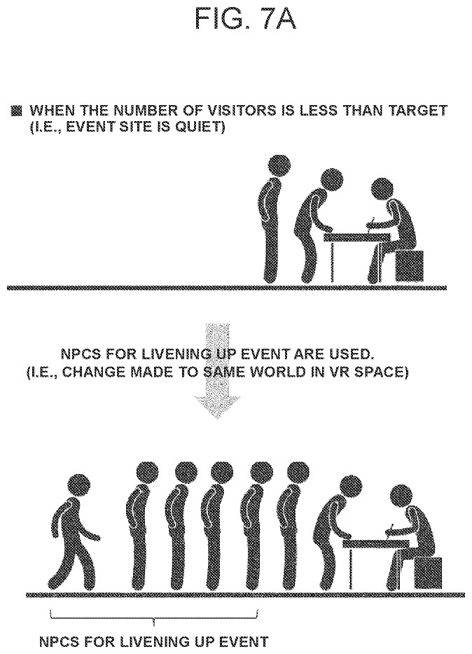

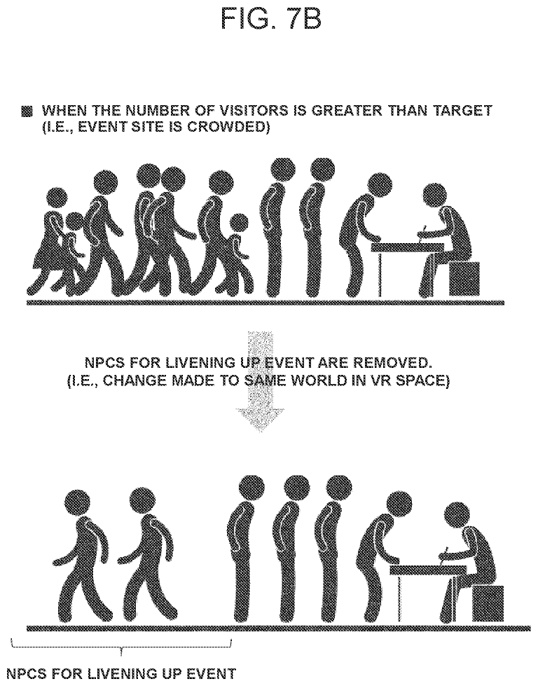

In addition, as illustrated in FIG. 7A, when the measurement value of “the number of visitors” is less than its target value (i.e., when the event site is quiet), a process of using NPCs for livening up the event (i.e., the process (d) above) is performed. This can create a lively atmosphere of the event, and thus allow other avatars to feel like entering the site. This in turn leads to an increase in the number of visitors. Meanwhile, as illustrated in FIG. 7B, when the measurement value of “the number of visitors” is greater than its target value (i.e., when the event site is crowded), a process of removing the NPCs for livening up the event (i.e., the process (k) above) is performed. This can reduce the number of avatars in the site (i.e., density), thus reducing congestion and creating an atmosphere that allows each avatar to stay comfortable within the site. This in turn can prevent a decrease in the number of visitors.

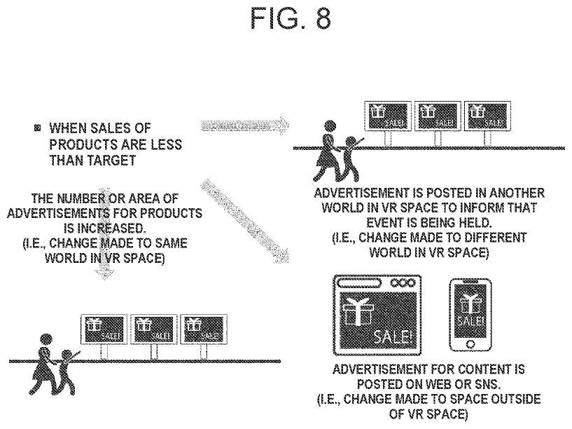

In an example illustrated in FIG. 5B, the following processes are stored in association with an assessment item “the sales of products” as a process for improving assessment (i.e., for promoting the sales of the products) when the measurement value of the assessment item is less than its target value: (a) increasing the number or area of advertisements for the products (e.g., digital signages or voice advertisements), (b) distributing discount coupons for the products, (c) setting a bargain time for the products, (d) using NPCs for livening up the event, (e) posting an advertisement for the products in another world in the VR space, (f) sending a message to an avatar in another world in the VR space to introduce the products, and (g) posting an advertisement for the products on a predetermined website or SNS. Meanwhile, the following processes are stored in association with the assessment item “the sales of products” as a process for maintaining the assessment (i.e., for continuing the sales of the products) when the measurement value of the assessment item is greater than its target value: (h) making endless sales (when the products sold are digital data), (i) displaying the number of unsold products in real time (when the products sold are currently in stock in the real world), (j) displaying information about the next arrival of products (when the products sold are currently in stock in the real world), and (k) changing the selling method from a first-come-first-served basis to lottery (when the products sold are currently in stock in the real world). Referring to FIG. 8, among them, the processes (a) to (d) and the processes (h) to (k) are applied to the world in which the event is being held in the VR space; the processes (e) and (f) are applied to a world different from the world in which the event is being held in the VR space; and the process (g) is applied to a space outside of the VR space.

In an example illustrated in FIG. 5C, the following processes are stored in association with an assessment item “social tipping status” as a process for improving assessment (i.e., for promoting the social tipping) when the measurement value of the assessment item is less than its target value: (a) changing the rendering of the content (b) changing the content, (c) increasing the number of contents provided, (d) using NPCs for livening up the event, (e) changing the social tipping item or its price, (f) posting an advertisement for the content in another world in the VR space, (g) sending a message to an avatar in another world in the VR space to introduce the content, and (h) posting an advertisement for the content on a predetermined website or SNS. Meanwhile, the following processes are stored in association with the assessment item “social tipping status” as a process for maintaining the assessment (i.e., for encouraging the continuance of the social tipping) when the measurement value of the assessment item is greater than its target value: (i) displaying the ranking of the amounts of social tipping, and (j) providing information on the next event or sending a reminder at a later date. Among them, the processes (a) to (e) and (i) are applied to the world in which the event is being held in the VR space; the processes (f) and (g) are applied to a world different from the world in which the event is being held in the VR space; and the process (h) is applied to a space outside of the VR space.

In an example illustrated in FIG. 5D, the following processes are stored in association with an assessment item “going-around-behavior” as a process for improving assessment (i.e., for improving fluidity) when the measurement value of the assessment item is less than its target value (i.e., when a guest avatar is unintentionally staying in one place or not going around many places): (a) displaying a signboard, (b) displaying an information guide or map, (c) setting up a warp door, (d) increasing the total area of the event site, (e) adding a passage(s) or widening a passage(s), (f) moving a product sales area or shop and the like, (g) expanding or adding a square(s), a park(s), and the like, (h) increasing the number of layers, and (i) using NPCs for livening up the event. Among them, the processes (a) to (i) are applied to the world in which the event is being held in the VR space.

In an example illustrated in FIG. 5E, the following processes are stored in association with an assessment item “feeling (emotions)” as a process for improving assessment (i.e., for increasing the number of guest users with a positive feeling) when the measurement value of the assessment item is less than its target value (i.e., when there are many guest users with a negative feeling): (a) changing the overall environment of the world (e.g., changing the music, sound, season, time, weather, or concept), (b) adding contents (e.g., adding parades, fireworks, or shops), (c) reducing congestion (i.e., making a change to create a comfortable environment) (e.g., increasing the area of the site, adding seats, increasing the number of layers, and removing the NPCs for livening up the event), (d) improving the isolated circumstance (e.g., using NPCs for livening up the event), and (e) holding a super bargain sale. Among them, the processes (a) to (e) are applied to the world in which the event is being held in the VR space.

Note that the storage unit 23 need not necessarily be provided in the server 2. For example, the storage unit 23 may be partially or entirely provided in another device that is communicably connected to the server 2 via the network 5.

As illustrated in FIG. 1B, the control unit 22 includes an input receiving unit 221, an event execution unit 222, and a report creation unit 223. The units 221 to 223 may be implemented through execution of predetermined programs by a processor in the server 2, or may be implemented by hardware.

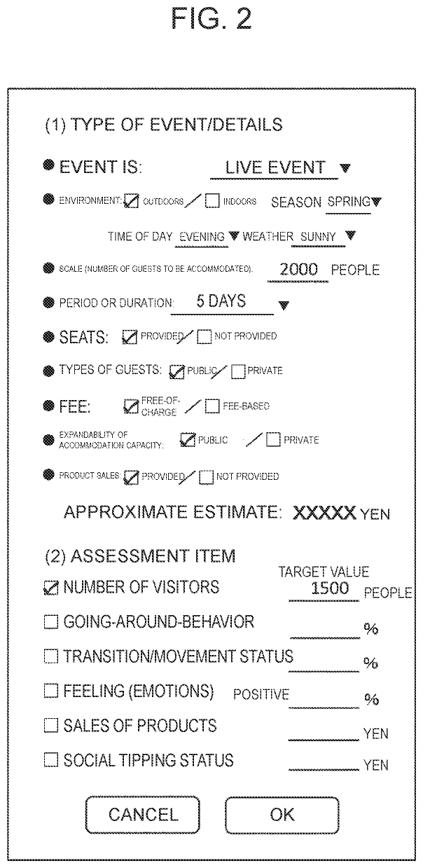

Among them, the input receiving unit 221 receives input of parameters for determining the specifications of an event to be held in the VR space (i.e., a VR event). For example, as illustrated in FIG. 2, the input receiving unit 221 may transmit to the host terminal 3 information on an input screen for prompting the input of parameters, and cause the display unit 35 of the host terminal 3 to display the information, and then receive from the host terminal 3 information on parameters input by a host user via the input unit 34 of the host terminal 3. The specifications of the VR event may include at least one of the following: the type of the VR event, whether the event is held outdoors or indoors, season, the time of the day, weather, the number of guests to be accommodated, period, duration, whether seats are provided, the types of the guests, whether the event is free-of-charge or fee-based, whether the accommodation capacity is expandable, and whether products are sold. As illustrated in FIG. 2, the input screen for prompting the input of parameters may present a plurality of predetermined candidates as the values of the parameters to be input, using a drop-down list or check boxes, for example, and accept selection of the values of the parameters to be input from among the plurality of candidates. Information on the parameters received by the input receiving unit 221 is stored in the event information database 231.

The input receiving unit 221 may create a mock-up image of the event through real-time rendering based on the input parameters. The created mock-up image is transmitted to the host terminal 3, and is displayed via the display unit 35 of the host terminal 3. Each time the input parameters are changed (i.e., each time the positions of checks in the check boxes are changed), the input receiving unit 221 corrects the mock-up image of the event based on the changed parameters, and then, the corrected mock-up image is transmitted to the host terminal 3, and is displayed via the display unit 35 of the host terminal 3. Accordingly, the host user is able to input parameters for determining the specifications of a VR event while checking and considering a mock-up image displayed on the display unit 35 of the host terminal 3, and thus is able to more easily create an event in the VR space. The created mock-up image is stored in the event information database 231.

The input receiving unit 221 may create an approximate estimate of the cost of the event in real time based on the input parameters. The created approximate estimate is transmitted to the host terminal 3, and is displayed via the display unit 35 of the host terminal 3. As illustrated in FIG. 2, the created approximate estimate may be displayed on the input screen for prompting the input of parameters. Each time the input parameters are changed (i.e., each time the positions of checks in the check boxes are changed), the input receiving unit 221 corrects the approximate estimate of the cost of the event based on the changed parameters, and then, the corrected approximate estimate is transmitted to the host terminal 3, and is displayed via the display unit 35 of the host terminal 3. Accordingly, the host user is able to input parameters for determining the specifications of a VR event while checking and considering an approximate estimate of the cost of the event displayed on the display unit 35 of the host terminal 3, and thus is able to more easily create an event in the VR space. The created approximate estimate is stored in the event information database 231.

The input receiving unit 221 further receives an input for setting an assessment item for a VR event and its target value. For example, as illustrated in FIG. 2, the input receiving unit 221 may cause the input screen for prompting the input of parameters to display an input area for prompting the input for setting an assessment item and its target value, and receive from the host terminal 3 information on an assessment item and its target value input by the host user via the input unit 34 of the host terminal 3. The assessment item for the VR event may include at least one of the number of visitors of the VR event, the number of downloads of an application for joining the VR event, the going-around-behavior of a guest within the site, the movement status of the guest between the areas inside and outside the site, the feeling of the guest, the sales of products, and the social tipping status. Among them, the feeling of the guest may be estimated based on at least one of the following biological information measured by the biological sensor 46 in one of the guest terminals 4a to 4c: the heart rate, a brain wave, a facial expression, an utterance, a pupil, a movement, and a physical action of the guest. As illustrated in FIG. 2, the input receiving unit 221 may present a plurality of predetermined candidates as an assessment item for a VR event, using check boxes, for example, and accept selection of the assessment item to be set from among the plurality of candidates. Information on the assessment item and its target value received by the input receiving unit 221 is stored in the event information database 231.

The input receiving unit 221 may, based on the input assessment item and its target value, create a review image of a process to be applied to the world in which the event is being held when the measurement value of the assessment item is less than or greater than the target value, through real-time rendering. The created review image is transmitted to the host terminal 3, and is displayed via the display unit 35 of the host terminal 3. Each time the input assessment item and its target value are changed (i.e., each time the position of check in the check boxes is changed), the input receiving unit 221 corrects, based on the changed assessment item and its target value, the review image of the process to be applied to the world in which the event is being held when the measurement value of the assessment item is less than or greater than the target value. Then, the corrected review image is transmitted to the host terminal 3, and is displayed via the display unit 35 of the host terminal 3. Accordingly, the host user is able to set an assessment item for a VR event and its target value while checking and considering a review image displayed on the display unit 35 of the host terminal 3, and thus is able to more easily set an assessment item and its target value.

A VR event to be executed is created based on the parameters received by the input receiving unit 221. The VR event to be executed may be created within the server 2, or may be created within another device that is communicably connected to the server 2 via the network 5.

The event execution unit 222 executes the VR event, which has been created based on the parameters received by the input receiving unit 221, in the VR space.

In the present embodiment, the event execution unit 222 performs measurement for the assessment item in real time while executing the VR event, and compares the measurement value of the assessment item with the set target value. Then, when the measurement value of the assessment item is less than the target value, the event execution unit 222 identifies a process for improving the assessment for the assessment item by referring to the database 232 that stores each assessment item and its corresponding process in association with each other, and then executes the identified process.

Meanwhile, when the measurement value of the assessment item is greater than the target value, the event execution unit 222 identifies a process for maintaining the assessment for the assessment item by referring to the database 232 that stores each assessment item and its corresponding process in association with each other, and then executes the identified process.

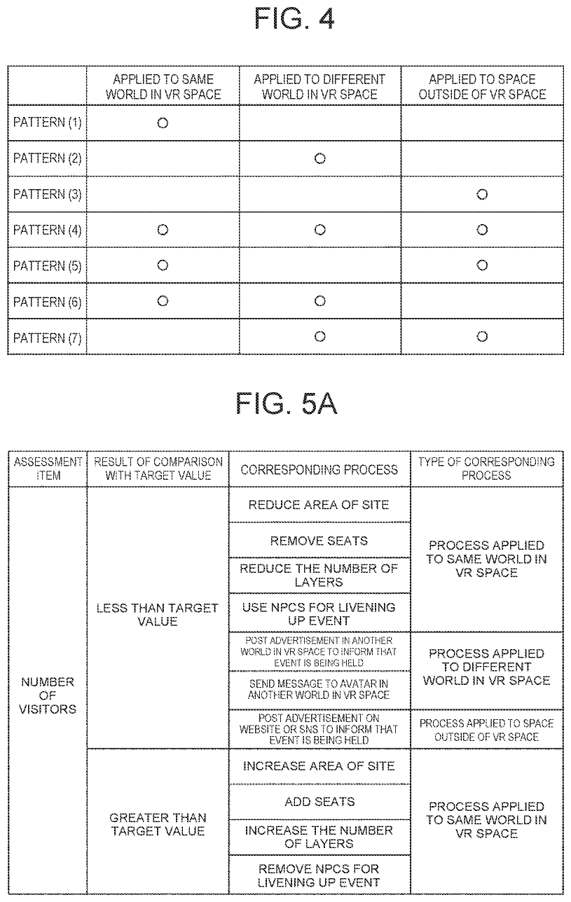

Herein, the process for improving or maintaining the assessment includes one or more of a process applied to the world in which the VR event is being held, a process applied to a world different from the world in which the VR event is being held, and a process applied to a space outside of the VR space. That is, as illustrated in FIG. 4, the event execution unit 222 may execute, as a process for improving or maintaining the assessment, (1) only a process applied to the world in which the VR event is being held, (2) only a process applied to a world different from the world in which the VR event is being held, (3) only a process applied to a space outside of the VR space, (4) all of a process applied to the world in which the VR event is being held, a process applied to a world different from the world in which the VR event is being held, and a process applied to a space outside of the VR space, (5) a process applied to the world in which the VR event is being held, and a process applied to a space outside of the VR space, (6) a process applied to the world in which the VR event is being held, and a process applied to a world different from the world in which the VR event is being held, or (7) a process applied to the world in which the VR event is being held, and a process applied to a space outside of the VR space.

Referring to FIGS. 5A to 5E, the process applied to the world in which the VR event is being held may include, more specifically, at least one of changing the number of layers to which avatars belong in the world, changing the overall environment of the world, sending a message to an avatar in the world, and changing the content in the world. Specifically, for example, the process applied to the world in which the event is being held may include at least one of changing the area of the site, changing the number of seats, changing the number of layers, changing the number of contents or non-player characters (NPCs) for livening up the event, changing the number or area of advertisements, distributing coupons, setting a bargain time, changing the social tipping item or its price, changing the display of a signboard or an information guide or map, setting up or removing a warp door, changing the number of passages, changing the passage width, moving a product sales area or shop, changing the area or number of squares or parks, and changing the music, sound, season, time, weather, or the overall concept of the world.

In addition, referring to FIGS. 5A to 5E, the process applied to a world different from the world in which the event is being held may include, more specifically, at least one of sending a message to an avatar in the different world, and changing the content in the different world.

Further, referring to FIGS. 5A to 5E, the process applied to a space outside of the VR space may include, more specifically, at least one of sending an e-mail or making a telephone call, posting on an SNS, posting on a website, posting on a digital signage, and changing the content in the real world. Herein, “changing the content in the real world” is also applicable to an audio content, an image, a video content, or the like in the real world (which means that the content is changed). Thus, such a process may be changing the type, details, rendering, or effect of the content, or inserting an alert or the like in the content. For example, when a reserved event has started in a VR space, the event execution unit 222 may, if a guest user is watching a video content using a display terminal other than the guest terminal 4 in the real world, transmit a control signal to the display terminal via the network 5 to display a pop-up on the video content watched by the user so as to inform the user that the reserved event has started in the VR space, or pause the playback of the video content. As another example, when the season in the VR space has turned to winter, the event execution unit 222 may transmit a control signal to an air-conditioning unit in a room in which a guest user is present in the real world via the network 5 so as to lower the temperature of the room in the real world.

As a modified example, the event execution unit 222 may, when the measurement value of the assessment item is less than (or greater than) the target value, identify a process for improving (or maintaining) the assessment for the assessment item by referring to the database 232 that stores each assessment item and its corresponding process in association with each other, and then manually execute the identified process based on a control signal received from the host terminal 3. For example, when an avatar operated by the owner of a shop opened in the VR event visits the shop in the VR event, the event execution unit 222 may perform a process of using NPCs for livening up the event based on a control signal received from the host terminal 3 so as to create an atmosphere that allows other avatars to feel like gathering in the shop. In addition, the event execution unit 222 may also stop the execution of the process for improving (or maintaining) the assessment for the assessment item based on a control signal received from the host terminal 3.

After execution of the VR event, the report creation unit 223 creates a report including time-series assessment for each assessment item. The created report is stored in the event information database 231, and is provided to a host user of the event.

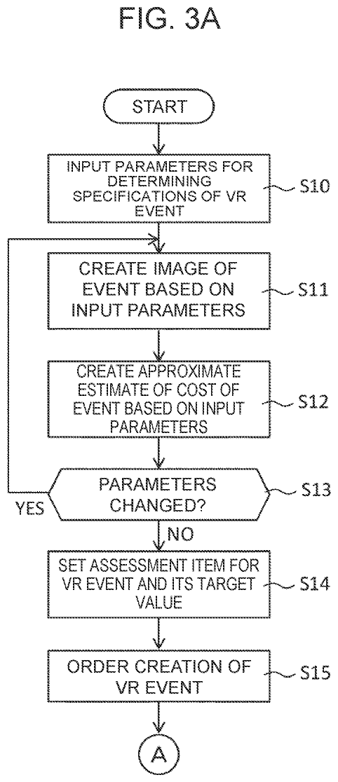

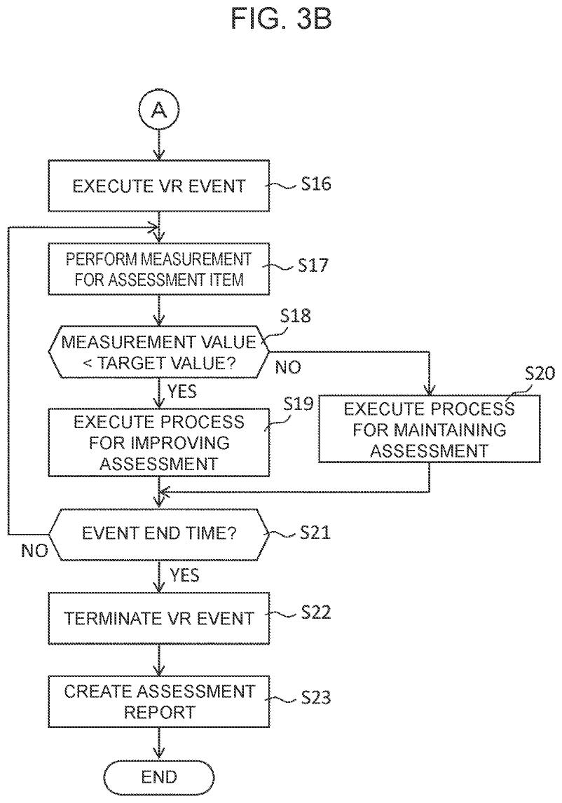

Next, an exemplary operation of the information processing system 1 with such a configuration will be described with reference to FIGS. 3A and 3B. FIGS. 3A and 3B are flowcharts illustrating an exemplary operation of the information processing system 1.

As illustrated in FIG. 3A, first, the input receiving unit 221 receives an input of parameters for determining the specifications of an event to be held in a VR space (i.e., a VR event) (step S10). For example, as illustrated in FIG. 2, the input receiving unit 221 may transmit to the host terminal 3 information on an input screen for prompting the input of parameters, and cause the display unit 35 of the host terminal 3 to display the information, and then receive from the host terminal 3 information on parameters input by a host user via the input unit 34 of the host terminal 3.

Next, the input receiving unit 221 creates a mock-up image of the event through real-time rendering based on the input parameters (step S11). The created mock-up image is transmitted to the host terminal 3, and is displayed via the display unit 35 of the host terminal 3.

In addition, the input receiving unit 221 creates an approximate estimate of the cost of the event in real time based on the input parameters (step S12). The created approximate estimate is transmitted to the host terminal 3, and is displayed via the display unit 35 of the host terminal 3. As illustrated in FIG. 2, the created approximate estimate may be displayed on the input screen for prompting the input of parameters.

The input receiving unit 221 determines if the input parameters are changed (e.g., the positions of checks in the check boxes are changed) (step S13).

If the input parameters are changed (step S13: YES), the input receiving unit 221 repeats the process of from step S11 again. That is, the input receiving unit 221 corrects the mock-up image of the event based on the changed parameters (step S11). The corrected mock-up image is transmitted to the host terminal 3, and is displayed via the display unit 35 of the host terminal 3. Accordingly, the host user is able to input parameters for determining the specifications of the VR event while checking and considering the mock-up image displayed on the display unit 35 of the host terminal 3, and thus is able to more easily create an event in the VR space. In addition, the input receiving unit 221 corrects the approximate estimate of the cost of the event based on the changed parameters (step S12). The corrected approximate estimate is transmitted to the host terminal 3, and is displayed via the display unit 35 of the host terminal 3. Accordingly, the host user is able to input parameters for determining the specifications of the VR event while checking and considering the approximate estimate of the cost of the event displayed on the display unit 35 of the host terminal 3, and thus is able to more easily create an event in the VR space.

Next, the input receiving unit 221 further receives an input for setting an assessment item for the VR event and its target value (step S14). For example, as illustrated in FIG. 2, the input receiving unit 221 may cause the input screen for prompting the input of parameters to display an input area for prompting the input for setting an assessment item and its target value, and receive from the host terminal 3 information on an assessment item and its target value input by the host user via the input unit 34 of the host terminal 3.

In the example illustrated in FIG. 2, after parameters for determining the specifications of a VR event are input, and also, an assessment item for the VR event and its target value are input, an “OK” button is pressed by the host user via the input unit 34 of the host terminal 3. Then, the creation of the VR event is ordered based on the input information on the parameters, the assessment item, and its target value (step S15).

Next, as illustrated in FIG. 3B, the event execution unit 222 executes the VR event, which has been created based on the parameters received by the input receiving unit 221, in the VR space (step S16).

Then, during the execution of the VR event, the event execution unit 222 performs measurement for the assessment item in real time (step S17), and compares the measurement value of the assessment item with the set target value (step S18).

If the measurement value of the assessment item is less than the target value (step S18: YES), the event execution unit 222 identifies a process for improving the assessment for the assessment item by referring to the database 232 that stores each assessment item and its corresponding process in association with each other, and executes the identified process (step S19). For example, if “the number of visitors” is set as the assessment item in step S14, and the measurement value of “the number of visitors” is less than the target value in step S18, the event execution unit 222 identifies a process of reducing the number of layers as the process for improving the assessment (i.e., for increasing the number of visitors) regarding “the number of visitors” by referring to the database 232 that stores each assessment item and its corresponding process in association with each other (see FIG. 5A), and executes the process. In such a case, as illustrated in FIG. 6A, reducing the number of layers can increase the number of avatars belonging to each layer (i.e., density). This can prevent a quiet atmosphere and create an atmosphere that allows other avatars to feel like entering the site. This in turn leads to an increase in the number of visitors.

Meanwhile, if the measurement value of the assessment item is greater than the target value (step S18: NO), the event execution unit 222 identifies a process for maintaining the assessment for the assessment item by referring to the database 232 that stores each assessment item and its corresponding process in association with each other, and executes the identified process (step S20). For example, if “the number of visitors” is set as the assessment item in step S14, and the measurement value of “the number of visitors” is greater than the target value in step S18, the event execution unit 222 identifies a process of increasing the number of layers as the process for maintaining the assessment (i.e., for not having less visitors) regarding “the number of visitors” by referring to the database 232 that stores each assessment item and its corresponding process in association with each other (see FIG. 5A), and executes the process. In such a case, as illustrated in FIG. 6B, increasing the number of layers can reduce the number of avatars belonging to each layer (i.e., density). This can reduce congestion and create an atmosphere that allows each avatar to stay comfortable within the site. This in turn can prevent a decrease in the number of visitors.

The event execution unit 222 determines if the end time of the VR event is reached (step S21). If the end time of the VR event is not reached (step S21: NO), the event execution unit 222 continues the execution of the VR event, and repeats the process of from step S17 again.

Meanwhile, if the end time of the VR event is reached (step S21: YES), the event execution unit 222 terminates the VR event (step S22).

After the execution of the VR event, the report creation unit 223 creates a report including time-series assessment for each assessment item (step S23). The created report is stored in the event information database 231, and is provided to the host user of the VR event.

As described above, according to the present embodiment, the input receiving unit 221 receives an input for setting an assessment item for a VR event and its target value. Then, during execution of the VR event, the event execution unit 222 performs measurement for the assessment item in real time, and compares the measurement value of the assessment item with the set target value. If the measurement value of the assessment item is less than the target value, the event execution unit 222 identifies a process for improving the assessment for the assessment item by referring to the database 232 that stores each assessment item and its corresponding process in association with each other, and executes the identified process. Accordingly, even when a measurement result for a predetermined assessment item has become less than its target value at a given time point during execution of an event in the VR space, a process for improving the assessment is executed immediately (in real time). This can recover from the low assessment of the VR event at an early point, and thus can increase the advantage of the event. Thus, it is possible to maximize the advantage of the event held in the VR space on a timely basis, utilizing the real-time property of the VR space.

Meanwhile, according to the present embodiment, if the measurement value of the assessment item is greater than the target value, the event execution unit 222 identifies a process for maintaining the assessment for the assessment item by referring to the database 232 that stores each assessment item and its corresponding process in association with each other, and executes the identified process. Accordingly, even when a measurement result for a predetermined assessment item has become greater than its target value at a given time point during execution of an event in the VR space, a process for maintaining the assessment is executed in real time. This can prevent the event from being assessed low during the execution of the event, and thus can even increase the advantage of the event. Thus, it is possible to even maximize the advantage of the event held in the VR space on a timely basis, utilizing the real-time property of the VR space.

Note that the description of the foregoing embodiment and the disclosure of the drawings are only examples for illustrating the claimed invention. Thus, the claimed invention is not limited by the description of the foregoing embodiment or the disclosure of the drawings. The components of the foregoing embodiment may be combined as appropriate within the scope and spirit of the invention.

The information processing system 1 according to the present embodiment can be at least partially configured with a computer. The subject of protection of the present application also includes a program for causing a computer to implement at least part of the information processing system 1 or 1B, and a non-transitory computer-readable recording medium having the program recorded thereon.

1. An information processing device comprising:
an input receiving unit that receives an input of a parameter for determining a specification of an event to be held in a virtual reality space; and
an event execution unit that executes in the virtual reality space an event created based on the parameter,
wherein:
the input receiving unit further receives an input for setting an assessment item for the event and a target value of the assessment item, and
during execution of the event, the event execution unit performs measurement for the assessment item in real time, and compares a measurement value of the assessment item with the set target value, and then, when the measurement value of the assessment item is less than the target value, identifies a process to be performed corresponding to the assessment item by referring to a database that stores a predetermined process for improving assessment for each assessment item, and executes the identified process.

2. The information processing device according to claim 1, wherein when the measurement value of the assessment item is greater than the target value, the event execution unit identifies a process to be performed corresponding to the assessment item by referring to a database that stores a predetermined process for maintaining assessment for each assessment item, and executes the identified process.

3. The information processing device according to claim 1, wherein the process includes one or more of a process applied to a world in which the event is being held, a process applied to a world different from the world in which the event is being held, and a process applied to a space outside of the virtual reality space.

4. The information processing device according to claim 3, wherein the process applied to the world in which the event is being held includes at least one of changing the number of layers to which avatars belong in the world, changing an overall environment of the world, sending a message to an avatar in the world, and changing a content in the world.

5. The information processing device according to claim 4, wherein the process applied to the world in which the event is being held includes at least one of changing an area of a site, changing the number of seats, changing the number of layers, changing the number of contents or non-player characters (NPCs) for livening up the event, changing the number or area of advertisements, distributing coupons, setting a bargain time, changing a social tipping item or a price of the social tipping item, changing a display of a signboard or an information guide or map, setting up or removing a warp door, changing the number of passages, changing a passage width, moving a product sales area or shop, changing an area or the number of squares or parks, and changing music, sound, season, time, weather, or an overall concept of the world.

6. The information processing device according to claim 3, wherein the process applied to a world different from the world in which the event is being held includes at least one of sending a message to an avatar in the different world, and changing a content in the different world.

7. The information processing device according to claim 3, wherein the process applied to a space outside of the virtual reality space includes at least one of sending an e-mail or making a telephone call, posting on an SNS, posting on a website, posting on a digital signage, and changing a content in the real world.

8. The information processing device according to claim 1, wherein the input receiving unit presents a plurality of predetermined candidates as an assessment item for the event, and receives selection of an assessment item to be set from among the plurality of candidates.

9. The information processing device according to claim 1, wherein the assessment item includes at least one of the number of visitors of the event, the number of downloads of an application for joining the event, going-around-behavior of a guest within the site, a movement status of the guest between areas inside and outside the site, feeling of the guest, sales of products, and a social tipping status.

10. The information processing device according to claim 9, wherein the feeling is estimated based on biological information including at least one of a heart rate, a brain wave, a facial expression, an utterance, a pupil, a movement, and a physical action of the guest.

11. The information processing device according to claim 1, wherein the specification of the event includes at least one of a type of the event, whether the event is held outdoors or indoors, season, time of a day, weather, the number of guests to be accommodated, a period, a duration, whether seats are provided, types of the guests, whether the event is free-of-charge or fee-based, whether an accommodation capacity is expandable, and whether products are sold.

12. The information processing device according to claim 1, wherein the input receiving unit creates a mock-up image of the event through real-time rendering based on the input parameter.

13. The information processing device according to claim 1, wherein the input receiving unit creates an approximate estimate of a cost of the event in real time based on the input parameter.

14. The information processing device according to claim 1, further comprising a report creation unit that, after execution of the event, creates a report including time-series assessment for each assessment item.

15. An information processing method implemented by a computer, the information processing method comprising:
a step of receiving an input of a parameter for determining a specification of an event to be held in a virtual reality space, the step further including receiving an input for setting an assessment item for the event and a target value of the assessment item; and
a step of executing in the virtual reality space an event created based on the parameter, the step further including, during execution of the event, performing measurement for the assessment item in real time, and comparing a measurement value of the assessment item with the set target value, and then, when the measurement value of the assessment item is less than the target value, identifying a process to be performed corresponding to the assessment item by referring to a database that stores a predetermined process for improving assessment for each assessment item, and executing the identified process.

16. A non-transitory computer-readable recording medium recording a information processing program for causing a computer to execute:
a step of receiving an input of a parameter for determining a specification of an event to be held in a virtual reality space, the step further including receiving an input for setting an assessment item for the event and a target value of the assessment item; and
a step of executing in the virtual reality space an event created based on the parameter, the step further including, during execution of the event, performing measurement for the assessment item in real time, and comparing a measurement value of the assessment item with the set target value, and then, when the measurement value of the assessment item is less than the target value, identifying a process to be performed corresponding to the assessment item by referring to a database that stores a predetermined process for improving assessment for each assessment item, and executing the identified process.
